(19) United States
(12) Patent Application Publication
(10) Pub. No.: US 2010/0243951 A1
(43) Pub. Date: Sep. 30, 2010

(54) NEGATIVE ELECTRODE MATERIAL FOR NONAQUEOUS ELECTROLYTE SECONDARY BATTERY, MAKING METHOD AND LITHIUM ION SECONDARY BATTERY

(75) Inventors: Kohichiro WATANABE, Annaka-shi (JP); Meguru Kashida, Annaka-shi (JP); Hirofumi Fukuoka, Annaka-shi (JP)

Correspondence Address: BIRCH STEWART KOLASCH & BIRCH, PO BOX 747, FALLS CHURCH, VA, 22040-0747, US

(73) Assignee: Shin-Etsu Chemical Co., Ltd., Tokyo (JP)

(21) Appl. No.: 12/731,044

(22) Filed: Mar. 24, 2010

(30) Foreign Application Priority Data
Mar. 25, 2009 (JP) 2009-073234

(51) Int. Cl. H01M 4/13; C23F 1/00

(52) U.S. Cl. 252/182.1; 216/79

(57) ABSTRACT

A negative electrode material comprising composite particles having silicon nano-particles dispersed in silicon oxide is suited for use in nonaqueous electrolyte secondary batteries. The silicon nano-particles have a size of 1-100 nm. The composite particles contain oxygen and silicon in a molar ratio: 0<O/Si<1.0. Using the negative electrode material, a lithium ion secondary battery can be fabricated which features high 1st cycle charge/discharge efficiency, capacity, and cycle performance.

### CROSS-REFERENCE TO RELATED APPLICATION

This non-provisional application claims priority under 35 U.S.C. §119(a) on Patent Application No. 2009-073234 filed in Japan on Mar. 25, 2009, the entire contents of which are hereby incorporated by reference.

### TECHNICAL FIELD

This invention generally relates to nonaqueous electrolyte secondary batteries, typically lithium ion secondary batteries. Specifically, it relates to negative electrode materials for use in such batteries and more particularly, to negative electrode materials having advantages of high 1st cycle charge/discharge efficiency, capacity and cycle performance when used as the negative electrode active material in lithium ion secondary batteries, and a method for preparing the same.

### BACKGROUND ART

In conjunction with the recent rapid advances of portable electronic equipment and communications instruments, nonaqueous electrolyte secondary batteries having a high energy density are strongly demanded from the aspects of cost, size and weight reductions. A number of measures are known in the art for increasing the capacity of such nonaqueous electrolyte secondary batteries. For example, JP 3008228 and JP 3242751 disclose negative electrode materials comprising oxides of B, Ti, V, Mn, Co, Fe, Ni, Cr, Nb, and Mo and composite oxides thereof. A negative electrode material comprising M₁₀₀₋ₓSiₓ wherein x≧50 at % and M=Ni, Fe, Co or Mn is obtained by quenching from the melt (JP 3846661). Other negative electrode materials are known as comprising silicon oxide (JP 2997741), and Si₂N₂O, Ge₂N₂O or Sn₂N₂O (JP 3918311).

Among others, silicon oxide is represented by SiOx wherein x is slightly greater than the theory of 1 due to oxide coating, and is found on X-ray diffractometry analysis to have the structure that nano-size silicon ranging from several to several tens of nanometers is finely dispersed in silicon oxide. The battery capacity of silicon oxide is smaller than that of silicon, but greater than that of carbon by a factor of 5 to 6 on a weight basis. Silicon oxide experiences a relatively less volume expansion. Silicon oxide is thus believed ready for use as the negative electrode active material. Nevertheless, silicon oxide has a substantial irreversible capacity and a very low initial efficiency of about 70%, which requires an extra battery capacity of the positive electrode when a battery is actually fabricated. Then an increase of battery capacity corresponding to the 5 to 6-fold capacity increase per active material weight is not expectable.

The problem of silicon oxide to be overcome prior to practical use is a substantially low initial efficiency. This may be overcome by making up the irreversible fraction of capacity or by restraining the irreversible capacity. The method of making up the irreversible fraction of capacity by previously doping silicon oxide with Li metal is reported effective. Doping of lithium metal may be carried out by attaching a lithium foil to a surface of negative electrode active material (JP-A 11-086847) or by vapor depositing lithium on a surface of negative electrode active material (JP-A 2007-122992). As for the attachment of a lithium foil, a thin lithium foil that matches with the initial efficiency of silicon oxide negative electrode is hardly available or prohibitively expensive if available. The deposition of lithium vapor makes the fabrication process complex and is impractical.

Aside from lithium doping, it is also disclosed to enhance the initial efficiency of negative electrode by increasing a weight proportion of silicon. One method is by adding silicon particles to silicon oxide particles to reduce the weight proportion of silicon oxide (JP 3982230). In another method, silicon vapor is generated and precipitated in the same stage as is produced silicon oxide, obtaining mixed solids of silicon and silicon oxide (JP-A 2007-290919). Silicon has both a high initial efficiency and a high battery capacity as compared with silicon oxide, but displays a percent volume expansion as high as 400% upon charging. Even when silicon is added to a mixture of silicon oxide and carbonaceous material, the percent volume expansion of silicon oxide is not maintained, and eventually at least 20 wt % of carbonaceous material must be added in order to suppress the battery capacity at 1,000 mAh/g. The method of obtaining the mixed solids by simultaneously generating silicon and silicon oxide vapors suffers from the working problem that the low vapor pressure of silicon necessitates the process at a high temperature in excess of 2,000° C.

Citation List

Patent Document 1: JP 3008228

Patent Document 2: JP 3242751

Patent Document 3: JP 3846661

Patent Document 4: JP 2997741

Patent Document 5: JP 3918311

Patent Document 6: JP-A 11-086847

Patent Document 7: JP-A 2007-122992

Patent Document 8: JP 3982230

Patent Document 9: JP-A 2007-290919

### SUMMARY OF INVENTION

An object of the invention is to provide a negative electrode material for non-aqueous electrolyte secondary batteries, which exhibits a high 1st cycle charge/discharge efficiency and improved cycle performance while maintaining the high battery capacity and low volume expansion of silicon oxide. Another object is to provide a method for preparing the negative electrode material and a lithium ion secondary battery using the same.

The inventors made efforts to search for a silicon base active material for non-aqueous electrolyte secondary battery negative electrode which has a high battery capacity surpassing carbonaceous materials, minimizes a change of volume expansion inherent to silicon based negative electrode active materials, and overcomes silicon oxide's drawback of a lowering of 1st cycle charge/discharge efficiency. As a result, the inventors found that when particles (represented by SiOx) having silicon nano-particles dispersed in silicon oxide are used as the negative electrode active material, oxygen in the silicon oxide reacts with lithium ion to form irreversible Li₄SiO₄, which causes a lowering of 1st cycle charge/discharge efficiency. That is, the negative electrode material obtained by adding silicon particles to silicon oxide particles as described in the preamble entails an eventual reduction of apparent oxygen content and results in an improvement in 1st cycle charge/discharge efficiency. However, even when silicon particles having selected physical properties are added, the electrode experiences a substantial volume expansion upon charging and an extreme drop of cycle performance. The inventors have found that by etching particles having silicon nano-particles of 1 to 100 nm size dispersed in silicon oxide in an acidic atmosphere, silicon dioxide can be selectively removed from the particles such that the resultant particles may contain oxygen and silicon in a molar ratio from more than 0 to less than 1.0. A negative electrode material comprising the resultant particles as the active material may be used to construct a nonaqueous electrolyte secondary battery having improved 1st cycle charge/discharge efficiency, a high capacity, and improved cycle performance. The invention is predicated on this finding.

In one aspect, the invention provides a negative electrode material for nonaqueous electrolyte secondary batteries, comprising composite particles having silicon nano-particles dispersed in silicon oxide, wherein the silicon nano-particles have a size of 1 to 100 nm and a molar ratio of oxygen to silicon is from more than 0 to less than 1.0.

In a preferred embodiment, the composite particles have been prepared by etching particles having silicon nano-particles dispersed in silicon oxide in an acidic atmosphere. In a preferred embodiment, the composite particles have an average particle size of 0.1 to 50 μm and a BET specific surface area of 0.5 to 100 m²/g. In a preferred embodiment of the negative electrode material, the composite particles are surface coated with carbon.

In another aspect, the invention provides a lithium ion secondary battery comprising the negative electrode material defined above.

In a further aspect, the invention provides a method for preparing the negative electrode material defined above, comprising the step of etching particles having silicon nano-particles dispersed in silicon oxide in an acidic atmosphere.

### ADVANTAGEOUS EFFECTS OF INVENTION

Using the negative electrode material of the invention, a lithium ion secondary battery can be fabricated which features a high 1st cycle charge/discharge efficiency, a high capacity, and improved cycle performance. The method for preparing the negative electrode material is simple and amenable to manufacture in an industrial scale.

### DESCRIPTION OF EMBODIMENTS

As used herein, the term “conductive” or “conductivity” refers to electrically conductive or electric conductivity.

The negative electrode material for nonaqueous electrolyte secondary batteries according to the invention comprises composite particles having silicon nano-particles dispersed in silicon oxide. The silicon nano-particles have a size of 1 to 100 nm. A molar ratio of oxygen to silicon is from more than 0 to less than 1.0, that is, 0<O/Si<1.0 wherein O/Si stands for a molar ratio of oxygen to silicon. The composite particles may be prepared by etching particles having silicon nano-particles dispersed in silicon oxide in an acidic atmosphere.

The starting particles, i.e., particles having silicon nano-particles dispersed in silicon oxide may be obtained by any desired methods, for example, by firing a mixture of fine particulate silicon and a silicon compound, or by heat treating silicon oxide particles of the formula: SiOx prior to disproportionation in an inert non-oxidizing atmosphere of argon or the like at a temperature of at least 400° C., preferably 800 to 1,100° C. for effecting disproportionation reaction. In particular, the material obtained by the latter method is preferred in that fine crystals of silicon are uniformly dispersed. Through disproportionation reaction, silicon nano-particles having a size of 1 to 100 nm can be produced. For the particles having silicon nano-particles dispersed in silicon oxide, the silicon oxide is preferably silicon dioxide. An observation of the particles under a transmission electron microscope (TEM) reveals that nano-particles or crystals of silicon are dispersed in amorphous silicon oxide.

As used herein, the term “silicon oxide” generally refers to amorphous silicon oxides. Silicon oxide prior to disproportionation reaction is represented by the general formula SiOx wherein x is in the range: 1.0≦x≦1.10. Silicon oxide may be produced by heating a mixture of silicon dioxide and metallic silicon to produce silicon monoxide gas and cooling the gas for precipitation.

The silicon oxide prior to disproportionation reaction and the particles having silicon nano-particles dispersed in silicon oxide have physical properties (e.g., particle size and surface area) which may be properly selected in accordance with the desired composite particles. For example, an average particle size of 0.1 to 50 μm is preferred. The lower limit of average particle size is more preferably at least 0.2 μm, and even more preferably at least 0.5 μm while the upper limit is more preferably up to 30 μm, and even more preferably up to 20 μm. As used herein, the “average particle size” refers to a weight average particle size in particle size distribution measurement by the laser light diffraction method. Also a BET specific surface area of 0.5 to 100 m²/g is preferred, with a range of 1 to 20 m²/g being more preferred.

The acidic atmosphere may be either an acidic aqueous solution or an acid-containing gas while its composition is not particularly limited. Suitable acids used herein include hydrogen fluoride, hydrochloric acid, nitric acid, hydrogen peroxide, sulfuric acid, acetic acid, phosphoric acid, chromic acid, and pyrophosphoric acid, which may be used alone or in admixture of two or more. The term “etching” means that the particles having silicon nano-particles dispersed in silicon oxide are treated with an acidic aqueous solution or an acidic gas, both containing an acid as mentioned just above. Treatment with an acidic aqueous solution may be performed by agitating the particles having silicon nano-particles dispersed in silicon oxide in an acidic aqueous solution. Treatment with an acid-containing gas may be performed by charging a reactor with the particles having silicon nano-particles dispersed in silicon oxide, feeding an acid-containing gas into the reactor, and treating the particles in the reactor. The acid concentration and treatment time may be suitably selected depending on the desired etching level. The treatment temperature is not particularly limited although a temperature of 0° C. to 1,200° C., especially 0° C. to 1,100° C. is preferred. A temperature in excess of 1,200° C. may cause excess growth of silicon crystals in the particles having silicon nano-particles dispersed in silicon oxide, leading to a reduced capacity.

While the particles having silicon nano-particles dispersed in silicon oxide are etched in an acidic atmosphere, silicon dioxide can be selectively removed from the particles such that the resultant particles (i.e., composite particles) may contain oxygen and silicon in a molar ratio: 0<O/Si<1.0.

The negative electrode material is preferably endowed with conductivity. Conductivity may be imparted by mixing the composite particles with conductive particles, typically carbon, and/or coating the composite particles with a carbon film. Coating with carbon may be preferably performed by subjecting the composite particles to chemical vapor deposition (CVD) in an organic compound gas. This may be achieved at a higher efficiency by feeding an organic compound gas into the reactor during heat treatment.

Specifically, the composite particles are subjected to CVD in an organic compound gas at a reduced pressure of 50 to 30,000 Pa and a temperature of 700 to 1,200° C. The pressure is preferably in a range of 50 to 10,000 Pa, more preferably 50 to 2,000 Pa. If CVD is under a pressure in excess of 30,000 Pa, the coated material may have a more fraction of graphitic material having graphite structure, leading to a reduced battery capacity and degraded cycle performance when used as the negative electrode material in nonaqueous electrolyte secondary batteries. The CVD temperature is preferably in a range of 800 to 1,200° C., more preferably 900 to 1,100° C. At a temperature below 700° C., a longer time may be necessary for the treatment. A temperature above 1,200° C. may cause fusion and agglomeration of particles during CVD treatment. Since a conductive coating is not formed at the agglomerated interface, the resulting material may suffer from degraded cycle performance when used as the negative electrode material in nonaqueous electrolyte secondary batteries. Although the treatment time may be suitably determined in accordance with the desired carbon coverage, treatment temperature, concentration (flow rate) and quantity of organic compound gas, and the like, a time of 1 to 10 hours, especially 2 to 7 hours is cost effective.

The organic compound used to generate the organic compound gas is a compound which is thermally decomposed, typically in a non-acidic atmosphere, at the heat treatment temperature to form carbon or graphite. Exemplary organic compounds include hydrocarbons such as methane, ethane, ethylene, acetylene, propane, butane, butene, pentane, isobutane, and hexane, alone or in admixture, mono- to tri-cyclic aromatic hydrocarbons such as benzene, toluene, xylene, styrene, ethylbenzene, diphenylmethane, naphthalene, phenol, cresol, nitrobenzene, chlorobenzene, indene, coumarone, pyridine, anthracene, and phenanthrene, alone or in admixture, and mixtures of the foregoing. Also, gas light oil, creosote oil and anthracene oil obtained from the tar distillation step are useful as well as naphtha cracked tar oil, alone or in admixture.

When the composite particles are coated with carbon, the coverage (or coating weight) of carbon is preferably 0.3 to 40%, and more preferably 0.5 to 30% by weight based on the carbon-coated composite particles, but not limited thereto. A carbon coverage of less than 0.3 wt % may fail to impart satisfactory conductivity, leading to degraded cycle performance when used as the negative electrode material in nonaqueous electrolyte secondary batteries. A carbon coverage of more than 40 wt % may achieve no further effect and correspond to a larger fraction of graphite in the negative electrode material, leading to a reduced charge/discharge capacity when used as the negative electrode material in nonaqueous electrolyte secondary batteries.

### Composite Particles

The composite particles have the structure in which silicon nano-particles are dispersed in silicon oxide. The composite particles contain oxygen and silicon in a molar ratio from more than 0 to less than 1.0, that is, 0<O/Si<1.0, preferably 0.7<O/Si<0.9. If O/Si≧1.0, no satisfactory etching effect is exerted. In too low a molar ratio, substantial expansion may occur upon charging.

In the composite particles, the silicon nano-particles have a size of 1 to 100 nm and preferably 3 to 10 nm. If the size of silicon nano-particles is too small, recovery after etching is difficult. Silicon nano-particles of too large size may adversely affect the cycle performance. The size may be measured under TEM.

The composite particles have physical properties which are not particularly limited. For example, an average particle size of 0.1 to 50 μm is preferred. The lower limit of average particle size is more preferably at least 0.2 μm and even more preferably at least 0.5 μm while the upper limit is more preferably up to 30 μm and even more preferably up to 20 μm. Particles with an average particle size of less than 0.1 μm have a greater specific surface area and may contain a higher fraction of silicon dioxide on particle surfaces, leading to a loss of battery capacity when used as the negative electrode material in nonaqueous electrolyte secondary batteries. Particles with an average particle size of more than 50 μm may become foreign matter when coated as an electrode, leading to degraded battery properties. As used herein, the “average particle size” refers to a weight average particle size in particle size distribution measurement by the laser light diffraction method.

Also a BET specific surface area of 0.5 to 100 m²/g is preferred, with a range of 1 to 20 m²/g being more preferred. Particles with a surface area of less than 0.5 m²/g may be less adherent when coated as an electrode, leading to degraded battery properties. Particles with a surface area of more than 200 m²/g may contain a higher fraction of silicon dioxide on particle surfaces, leading to a loss of battery capacity when used as the negative electrode material in nonaqueous electrolyte secondary batteries.

### Negative Electrode Material

Disclosed herein is a negative electrode material for nonaqueous electrolyte secondary batteries, comprising as an active material, composite particles having silicon nano-particles with a size of 1 to 100 nm dispersed in silicon oxide and satisfying 0<O/Si<1.0. A negative electrode may be prepared using the negative electrode material, and a lithium ion secondary battery may be constructed using the negative electrode.

When a negative electrode is prepared using the negative electrode material, a conductive agent such as carbon or graphite may be added to the material. The type of conductive agent used herein is not particularly limited as long as it is an electronically conductive material which does not undergo decomposition or alteration in the battery. Illustrative conductive agents include metals in powder or fiber form such as Al, Ti, Fe, Ni, Cu, Zn, Ag, Sn and Si, natural graphite, synthetic graphite, various coke powders, meso-phase carbon, vapor phase grown carbon fibers, pitch base carbon fibers, PAN base carbon fibers, and graphite obtained by firing various resins.

From the negative electrode material, a negative electrode (shaped form) may be prepared, for example, by the following procedure. The negative electrode is prepared by combining the active material (i.e., composite particles having silicon nano-particles dispersed in silicon oxide and satisfying 0<O/Si<1.0) and optional additives such as conductive agent and binder, kneading them in a solvent such as water or N-methylpyrrolidone to form a paste-like mix, and applying the mix in sheet form to a current collector. The current collector used herein may be a foil of any material which is commonly used as the negative electrode current collector, for example, a copper or nickel foil while the thickness and surface treatment thereof are not particularly limited. The method of shaping or molding the mix into a sheet is not limited, and any well-known method may be used.

### Lithium Ion Secondary Battery

The lithium ion secondary battery is characterized by the use of the negative electrode material while the materials of the positive electrode, negative electrode, electrolyte, and separator and the battery design may be well-known ones and are not particularly limited. For example, the positive electrode active material used herein may be selected from transition metal oxides such as LiCoO₂, LiNiO₂, LiMn₂O₄, V₂O₅, MnO₂, TiS₂ and MoS₂, lithium, and chalcogen compounds. The electrolytes used herein may be lithium salts such as lithium hexafluorophosphate and lithium perchlorate in nonaqueous solution form. Examples of the nonaqueous solvent include propylene carbonate, ethylene carbonate, diethyl carbonate, dimethoxyethane, γ-butyrolactone and 2-methyltetrahydrofuran, alone or in admixture. Use may also be made of other various non-aqueous electrolytes and solid electrolytes.

### Electrochemical Capacitor

A further embodiment is an electrochemical capacitor which is characterized by comprising the negative electrode material described above, while other materials such as electrolyte and separator and capacitor design are not particularly limited. Examples of the electrolyte used include nonaqueous solutions of lithium salts such as lithium hexafluorophosphate, lithium perchlorate, lithium borofluoride, and lithium hexafluoroarsenate, and exemplary nonaqueous solvents include propylene carbonate, ethylene carbonate, dimethyl carbonate, diethyl carbonate, dimethoxyethane, γ-butyrolactone, and 2-methyltetrahydrofuran, alone or a combination of two or more. Other various nonaqueous electrolytes and solid electrolytes may also be used.

### EXAMPLE

Examples of the invention are given below by way of illustration and not by way of limitation.

### Example 1

In an argon stream, 100 g of particles of SiOx (x=1.01) having an average particle size of 5 μm and a BET specific surface area of 3.5 m²/g was heat treated at 1,000° C. for 3 hours. When observed under a transmission electron microscope (TEM), the heat treated particles were found to have the structure in which silicon nano-particles were dispersed in silicon oxide.

At room temperature, the heat treated powder was fed into a 2-L plastic bottle where it was wetted with 30 mL of methanol, after which 200 mL of deionized water was added. After the entire powder was infiltrated and contacted with deionized water, 5 mL of 50 wt % hydrofluoric acid aqueous solution was gently added and stirred. The resulting mixture had a hydrofluoric acid concentration of 1.1 wt % or contained 2.5 g of hydrogen fluoride relative to 100 g of the heat treated powder. The mixture was allowed to stand at room temperature for one hour for etching.

The etching treatment was followed by washing with deionized water and filtration. The powder was dried in vacuum at 120° C. for 5 hours, obtaining 92.5 g of particles. Using an analyzer EMGA-920 by Horiba Mfg. Co., Ltd., the particles were measured to have an oxygen concentration of 32.3 wt %, indicating an oxygen/silicon molar ratio of 0.84.

A batchwise heating furnace was charged with the particles. The furnace was evacuated to vacuum by means of an oil sealed rotary vacuum pump while it was heated to 1,100° C. Once the temperature was reached, CH₄ gas was fed at 0.3 NL/min through the furnace where carbon coating treatment was carried out for 5 hours. A reduced pressure of 800 Pa was kept during the treatment. At the end of treatment, the furnace was cooled down, recovering 97.5 g of black particles. The black particles had an average particle size of 5.2 μm and a BET specific surface area of 6.5 m²/g, and were conductive due to a carbon coverage of 5.1 wt % based on the black particles. When observed under TEM, the black particles were found to have the structure in which silicon nano-particles were dispersed in silicon oxide and had a size of 5 nm.

Cell Test

The effectiveness of particles as a negative electrode material was evaluated by the following cell test. The black particles, 45 wt %, was combined with 45 wt % of synthetic graphite having an average particle size of 10 μm and 10 wt % of polyimide. Then N-methylpyrrolidone was added to the mixture to form a slurry. The slurry was coated onto a copper foil of 12 μm gage and dried at 80° C. for one hour. Using a roller press, the coated foil was shaped under pressure into an electrode sheet. The electrode sheet was vacuum dried at 350° C. for 1 hour, after which discs of 2 cm² were punched out as the negative electrode.

To evaluate the charge/discharge characteristics of the disc as the negative electrode, a test lithium ion secondary cell was constructed using a lithium foil as the counter electrode. The electrolyte solution used was a nonaqueous electrolyte solution of lithium hexafluorophosphate in a 1/1 (by volume) mixture of ethylene carbonate and diethyl carbonate in a concentration of 1 mol/liter. The separator used was a porous polyethylene film of 30 μm thick.

The lithium ion secondary cell thus constructed was allowed to stand overnight at room temperature. Using a secondary cell charge/discharge tester (Nagano K. K.), a charge/discharge test was carried out on the cell. Charging was conducted with a constant current flow of 0.5 mA/cm² until the voltage of the test cell reached 0 V, and after reaching 0 V, continued with a reduced current flow so that the cell voltage was kept at 0 V, and terminated when the current flow decreased below 40 μA/cm². Discharging was conducted with a constant current flow of 0.5 mA/cm² and terminated when the cell voltage reached 1.4 V, from which a discharge capacity was determined.

By repeating the above operation, the charge/discharge test was carried out 50 cycles on the lithium ion secondary cell. The cell marked an initial (1st cycle) charge capacity of 2,150 mAh/g, an initial discharge capacity of 1,720 mAh/g, an initial charge/discharge efficiency of 80%, a 50-th cycle discharge capacity of 1,496 mAh/g, and a cycle retentivity of 87% after 50 cycles, indicating a high capacity. It was a lithium ion secondary cell having improved 1st cycle charge/discharge efficiency and cycle performance.

### Example 2

As in Example 1, etching treatment was carried out on the same heat treated particles as in Example 1 except that the amount of 50 wt % hydrofluoric acid aqueous solution was changed from 5 mL to 57.5 mL (the resulting mixture had a hydrofluoric acid concentration of 10 wt % or contained 28.75 g of hydrogen fluoride relative to 100 g of the heat treated powder). There were recovered 90.6 g of black particles. The particles prior to carbon coating had an oxygen concentration of 29.4 wt %, indicating an oxygen/silicon molar ratio of 0.73. The black particles (after carbon coating) had an average particle size of 5.1 μm and a BET specific surface area of 18.8 m²/g, and were conductive due to a carbon coverage of 4.9 wt % based on the black particles. When observed under TEM, the black particles were found to have the structure in which silicon nano-particles were dispersed in silicon oxide and had a size of 5 nm.

As in Example 1, a negative electrode was prepared and evaluated by a cell test. The cell marked an initial charge capacity of 2,240 mAh/g, an initial discharge capacity of 1,814 mAh/g, an initial charge/discharge efficiency of 81%, a 50-th cycle discharge capacity of 1,469 mAh/g, and a cycle retentivity of 82% after 50 cycles, indicating a high capacity. It was a lithium ion secondary cell having improved 1st cycle charge/discharge efficiency and cycle performance.

### Example 3

At room temperature, a stainless steel chamber was charged with 100 g of the heat treated powder in Example 1. Hydrofluoric acid gas diluted to 30% by volume with nitrogen was flowed through the chamber for 1 hour. After the hydrofluoric acid gas flow was interrupted, the chamber was purged with nitrogen gas until the HF concentration of the outgoing gas as monitored by a FT-IR monitor decreased below 5 ppm. Thereafter, particles were taken out, which weighed 94.5 g and had an oxygen concentration of 33.4 wt %, indicating an oxygen/silicon molar ratio of 0.88.

The particles were coated with carbon as in Example 1, recovering 105.5 g of black particles. The black particles had an average particle size of 5.3 μm, a BET specific surface area of 6.3 m²/g, and a carbon coverage of 5.2 wt % based on the black particles. When observed under TEM, the black particles were found to have the structure in which silicon nano-particles were dispersed in silicon oxide and had a size of 5 nm.

As in Example 1, a negative electrode was prepared and evaluated by a cell test. The cell marked an initial charge capacity of 2,130 mAh/g, an initial discharge capacity of 1,682 mAh/g, an initial charge/discharge efficiency of 79%, a 50-th cycle discharge capacity of 1,478 mAh/g, and a cycle retentivity of 88% after 50 cycles, indicating a high capacity. It was a lithium ion secondary cell having improved 1st cycle charge/discharge efficiency and cycle performance.

### Comparative Example 1

The heat treated particles in Example 1 were directly (without etching treatment) subjected to the carbon coating treatment in Example 1. The black particles had an average particle size of 5.1 μm, a BET specific surface area of 5.1 m²/g, and a carbon coverage of 5.0 wt % based on the black particles.

As in Example 1, a negative electrode was prepared and evaluated by a cell test. The cell marked an initial charge capacity of 2,030 mAh/g, an initial discharge capacity of 1,482 mAh/g, an initial charge/discharge efficiency of 73%, a 50-th cycle discharge capacity of 1,275 mAh/g, and a cycle retentivity of 86% after 50 cycles. This lithium ion secondary cell was apparently inferior in discharge capacity and 1st cycle charge/discharge efficiency to Example 1.

The test results of Examples 1 to 3 and Comparative Example 1 are summarized in Table 1.

### Comparative Example 2

The particles of SiOx (x=1.01) containing silicon nano-particles with a size of 0.8 nm, with which Example 1 started, were directly (without heat treatment) subjected to etching treatment with a hydrofluoric acid aqueous solution in a hydrofluoric acid concentration of 1.1 wt % as in Example 1. After the mixture was allowed to stand, it was washed and filtered. The recovery rate of particles was as low as 30%. The process is not regarded practically acceptable.

TABLE 1

| | | | Initial | Initial | | Retentivity |
|---|---|---|---|---|---|---|
| | | O/S1 | charge | discharge | Initial | after |
| | | molar | capacity, | capacity, | efficiency, | 50 cycles, |
| | O, wt % | ratio | mAh/g | mAh/g | % | % |
| Example 1 | 32.3 | 0.84 | 2150 | 1720 | 80 | 87 |
| Example 2 | 29.4 | 0.73 | 2240 | 1814 | 81 | 82 |
| Example 3 | 33.4 | 0.88 | 2130 | 1682 | 79 | 88 |
| Comparative | 36.5 | 1.01 | 2030 | 1482 | 73 | 86 |
| Example 1 | | | | | | |

Japanese Patent Application No. 2009-073234 is incorporated herein by reference.

Although some preferred embodiments have been described, many modifications and variations may be made thereto in light of the above teachings. It is therefore to be understood that the invention may be practiced otherwise than as specifically described without departing from the scope of the appended claims.

1. A negative electrode material for nonaqueous electrolyte secondary batteries, comprising composite particles having silicon nano-particles dispersed in silicon oxide, wherein the silicon nano-particles have a size of 1 to 100 nm and a molar ratio of oxygen to silicon is from more than 0 to less than 1.0.

2. The negative electrode material of claim 1 wherein the composite particles have been prepared by etching particles having silicon nano-particles dispersed in silicon oxide in an acidic atmosphere.

3. The negative electrode material of claim 1 wherein the composite particles have an average particle size of 0.1 to 50 μm and a BET specific surface area of 0.5 to 100 m²/g.

4. The negative electrode material of claim 1 wherein the composite particles are surface coated with carbon.

5. A lithium ion secondary battery comprising the negative electrode material of claim 1.

6. A method for preparing the negative electrode material of claim 1, comprising the step of etching particles having silicon nano-particles dispersed in silicon oxide in an acidic atmosphere.
